(19) United States
(12) Patent Application Publication
(10) Pub. No.: US 2008/0245936 A1
(43) Pub. Date: Oct. 9, 2008

(54) Pocketed drape pole truss hanger

(76) Inventor: Joseph Dominic Frascella, Marietta, GA (US)

Correspondence Address: JOSEPH DOMINIC FRASCELLA, JR., 4254 CREEK HAVEN DR., MARIETTA, GA, 30062, US

(21) Appl. No.: 12/075,266

(22) Filed: Feb. 4, 2008

Related U.S. Application Data
(60) Provisional application No. 60/921,512, filed on Apr. 3, 2007.

(51) Int. Cl. F21V 17/10

(52) U.S. Cl. 248/215; 248/340

(57) ABSTRACT

A device for easily attaching telescoping or non-telescoping horizontal drapery support crossbars to theatrical lighting truss. A hollow tube with receiving slots cut into it is attached to a hook shaped hanger that provides a means of attaching the assembly to the pipe of a theatrical lighting truss. The hook shaped hanger has a bend in it at the opposite end from the hook to help prevent the assembly from coming off the truss. Receiving slots are provided along the sides of the hollow tube to allow the drape support crossbar to be hung from the assembly by its hook.

### RELATED APPLICATIONS

The present application is a continuation-in-part application of U.S. provisional patent application Ser. No. 60/921,512, filed Apr. 3, 2007, for POCKETED DRAPE POLE TRUSS HANGER, by Joseph Dominic Frascella Jr, included by reference herein and for which benefit of the priority date is hereby claimed.

### FIELD OF THE INVENTION

The present invention relates to drapery hangers and, more particularly, to a hanger to support telescoping and non-telescoping horizontal drapery support crossbars from theatrical lighting truss.

### BACKGROUND OF THE INVENTION

The event staging industry uses self supporting drapery systems as backdrops for stage areas. The drape in these systems are supported by telescopic uprights, horizontal crossbars and steel base components. These systems can be difficult to setup and maintaining a straight and even drape line can also be difficult. At times, attaching this drape system to a suspended theatrical lighting truss assembly is preferred. Currently the most usual way that the drape is attached to the truss is by tying it to the truss using rope, wire or a similar method.

I have invented a simple one piece bracket that attaches to the theatrical lighting truss and allows for the hooks on the ends of the horizontal drapery support crossbars to be attached to this bracket. This bracket being of a single piece design, is extremely easy to use.

There is an existing product, sold by In-House Production, that performs the function of securing drapery telescoping crossbars to 2″ pipe or truss.

The shortcoming of the In-House Production product is that it uses a clamping method to attach itself to both the crossbar and the pipe or truss. It has several pieces that can become lost or damaged and can be cumbersome for a single person to use. The clamping method used by this product also requires more time to assemble and therefore has a higher difficulty level to use. The clamping method also prevents end to end attachment of the crossbar.

It is therefore an object of the invention to allow for the easy attachment of temporary drapery systems to theatrical lighting truss.

It is another object of the invention to shorten the amount of time required to attach the temporary drapery systems to the theatrical lighting truss.

It is another object of the invention to provide a safe and secure method of attaching temporary drapery systems to the theatrical lighting truss.

### SUMMARY OF THE INVENTION

In accordance with the present invention, there is provided a device for easily attaching horizontal drapery support crossbars to theatrical lighting truss. A hollow tube with receiving apertures cut into it is permanently attached to a hook shaped hanger that provides a means of attaching the assembly to the pipe of a theatrical lighting truss. The hook shaped hanger is bent to form a catch at the end opposite from the hook to help prevent the assembly from dislodging from the truss. Receiving apertures are provided along the sides of the hollow tube to allow the horizontal drape support crossbar to be hung from and supported by the hanger as it is attached to the theatrical lighting truss.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a drape hanger in accordance with invention showing all views;

FIG. 2 is a plan view of a typical drape crossbar;

FIG. 3 is a perspective view of a pair of hangers supporting a drapery crossbar; and

FIG. 4 is a left perspective view of a hanger attached to a theatrical truss.

For purposes of clarity and brevity, like elements and components will bear the same designations and numbering throughout the Figures.

### DESCRIPTION OF THE PREFERRED EMBODIMENT

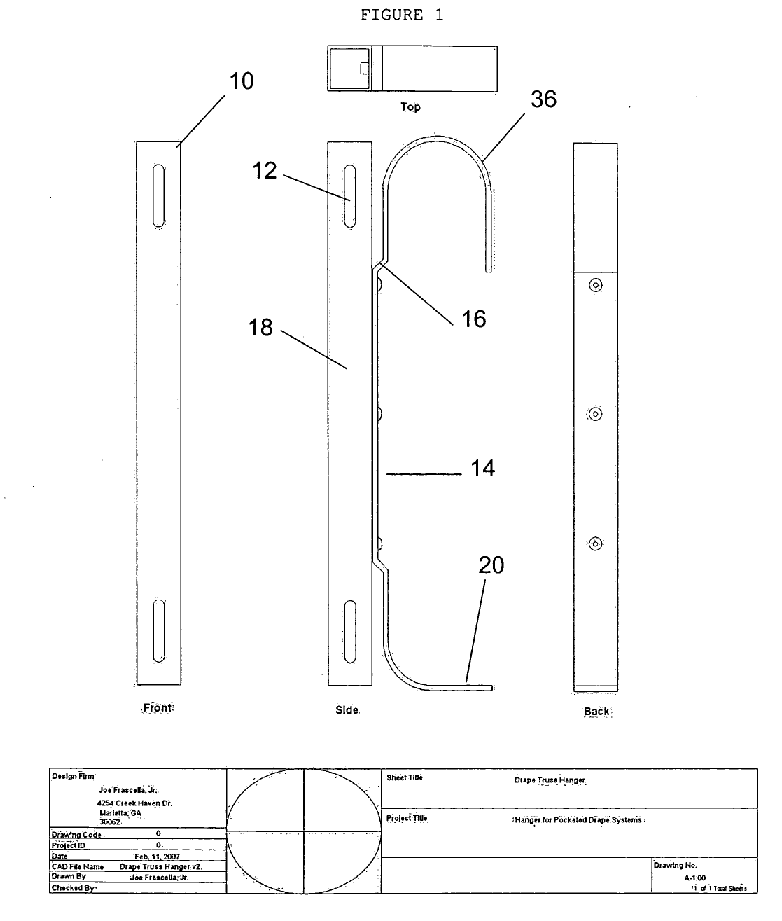

FIG. 1 is a detail view of a drape hanger 18 in accordance with invention, showing all views. The drape hanger 18 can be made with any material with suitable strength characteristics.

Tube 10 is attached to hanger 14 by welding, mechanically fastening or gluing in a manner well known to those skilled in the art and appropriate for the materials in use. A plurality of spaced apart aperture 12 are cut along the sides of the tube 10. An aperture 12 is used to receive the end hook 30 found on the horizontal drape support crossbar 32. The hanger 14 is offset 16 away from the tube 10 by a bend or by spacers so as to provide clearance for the horizontal drape support crossbar 32.

A horizontal bend is put into the end opposite from the hook 36 end of the hanger 14 to act as a catch 20 to prevent the hanger 14 assembly from dislodging from the theatrical lighting truss

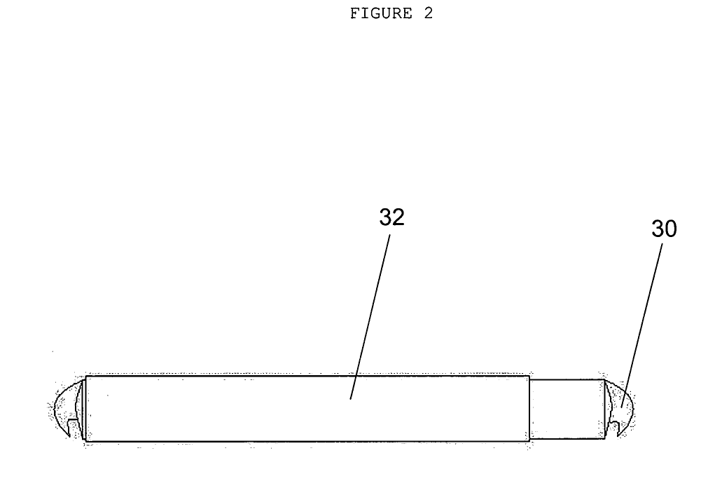

FIG. 2 is for reference and shows what a typical horizontal drape support crossbar 32 looks like. The end hook 30 is shown and is the part of the crossbar 32 which attaches to the drape hanger 18. The drape crossbar 32 is equipped with an end hook 30 at each end. A drape hanger 18 is used at both ends of crossbar 32, the end hook 30 is positioned in aperture 12 of drape hanger 18 to provide support for the crossbar 32.

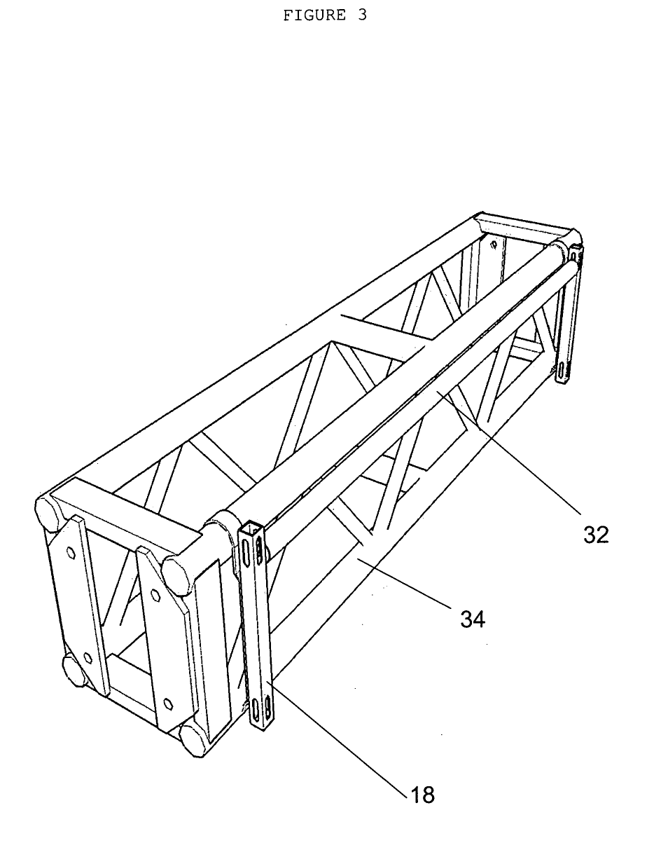

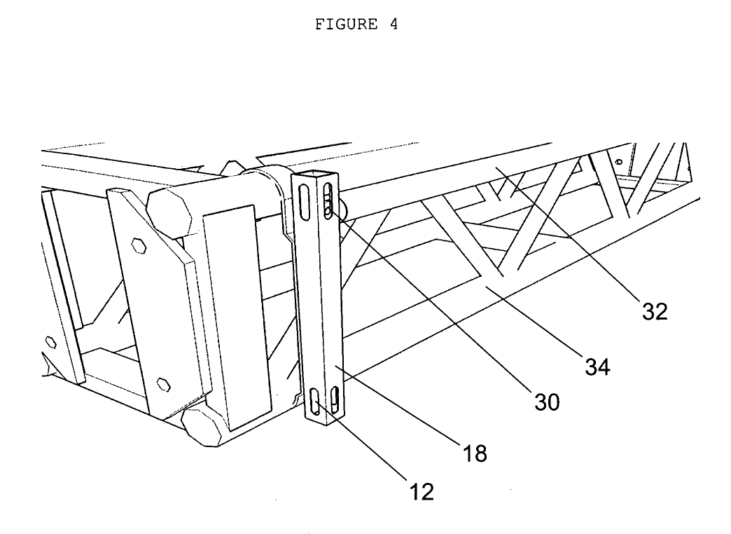

FIGS. 3 and 4 are for reference and show one way in which the hanger 14 might be attached to theatrical truss 34 and how it might be used to support a typical horizontal drape support crossbar 32 by means of attaching the crossbar 32 end hook 30 into the aperture 12 on the drape hanger 18.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A pocketed drape pole truss hanger for hanging a horizontal drapery support crossbar from theatrical lighting truss, comprising:
means for attachment of the drape crossbar;
means for connection of drape support crossbar hook;
means for mounting of assembly to the theatrical lighting truss, securely connected to said means for attachment of the drape crossbar;
means for preventing said hanger from moving in an upwards direction displacing said hanger from the truss; and
means for attaching said hanger to truss pipe.

2. The pocketed drape pole truss hanger in accordance with claim 1, wherein said means for attachment of the drape crossbar comprises a hollow tube.

3. The pocketed drape pole truss hanger in accordance with claim 1, wherein said means for connection of drape support crossbar hook comprises an in tube, along sides of aperture.

4. The pocketed drape pole truss hanger in accordance with claim 1, wherein said means for mounting of assembly to the theatrical lighting truss comprises a hooked, rigid hanger.

5. The pocketed drape pole truss hanger in accordance with claim 1, wherein said means for preventing said hanger from moving in an upwards direction displacing said hanger from the truss comprises a safety, retainer, horizontally oriented catch.

6. The pocketed drape pole truss hanger in accordance with claim 1, wherein said means for attaching said hanger to truss pipe comprises a sized hook.

7. A pocketed drape pole truss hanger for hanging a horizontal drapery support crossbar from theatrical lighting truss, comprising:
a hollow tube, for attachment of the drape crossbar;
an in tube, along sides of aperture, for connection of drape support crossbar hook;
a hooked, rigid hanger, for mounting of assembly to the theatrical lighting truss, securely connected to said tube;
a safety, retainer, horizontally oriented catch, for preventing said hanger from moving in an upwards direction displacing said hanger from the truss; and
a sized hook, for attaching said hanger to truss pipe.

8. A pocketed drape pole truss hanger for hanging a horizontal drapery support crossbar from theatrical lighting truss, comprising:
a hollow tube, for attachment of the drape crossbar;
an in tube, along sides of aperture, for connection of drape support crossbar hook;
a hooked, rigid hanger, for mounting of assembly to the theatrical lighting truss, securely connected to said tube;
a safety, retainer, horizontally oriented catch, for preventing said hanger from moving in an upwards direction displacing said hanger from the truss; and
a sized hook, for attaching said hanger to truss pipe.
